(19) United States
(12) Patent Application Publication
(10) Pub. No.: US 2009/0112538 A1
(43) Pub. Date: Apr. 30, 2009

(54) VIRTUAL REALITY SIMULATIONS FOR HEALTH CARE CUSTOMER MANAGEMENT

(76) Inventors: Joel Anderson, Appleton, WI (US); Rameshbabu Boga, Alpharetta, GA (US); Daniel Bowman, Seattle, WA (US); Valerie Cansler, Roswell, GA (US); Gary Clement, Alexandria, VA (US); Sudhanshu Gakhar, Neenah, WI (US); Patrick Hastings, Combined Locks, WI (US); William Lynch, Greenville, WI (US); Erica Phillips, Woodstock, GA (US); Sridhar Ranganathan, Suwanee, GA (US); Richard Timmers, Bear, DE (US)

Correspondence Address: Christopher M. Goff (27839);ARMSTRONG TEASDALE LLP, ONE METROPOLITAN SQUARE, SUITE 2600, ST. LOUIS, MO, 63102, US

(21) Appl. No.: 11/925,713

(22) Filed: Oct. 26, 2007

(51) Int. Cl. G06G 7/48; G06Q 50/00

(52) U.S. Cl. 703/6

(57) ABSTRACT

Embodiments of the invention provide virtual reality tools and simulations used for improved health care customer management. The virtual reality tools may be used by a product manufacturer or seller to assist in relationship management with health care partners including identifying improved solutions for a variety of problems, strengthening infection prevention processes and systems, improving order and flow in the operating room and other care-delivery environments, identifying benefits from new products, providing techniques for evaluating new health care systems and processes, etc.

### BACKGROUND OF THE INVENTION

1. Field of the Invention

Embodiments of the present invention generally relate to virtual reality simulations. More particularly, embodiments of the invention relate to virtual reality tools and simulations used for health care customer management.

2. Description of the Related Art

Providing healthcare services to patients is an extremely complex business. One often overlooked aspect of providing healthcare services is the order and flow of a variety of products used within a healthcare environment. Generally, “order and flow” refers to how products are delivered, stored, used, and disposed of within a given environment, e.g., how hospital staff interacts with product dispensers, medical devices, bandages, disinfectants, soap, dispensing stations, etc.

Frequently, medical procedures are performed as a carefully choreographed sequence of events, and within such a sequence, the order, placement or positioning of products can have substantial impacts on the efficiency and/or effectiveness of a given procedure. Evaluating such procedures, as well as testing different alternatives can be very difficult.

At the same time, product manufacturers and sellers have a strong incentive to demonstrate to a health care customer that their products, services, or approaches may improve the efficiency or effectiveness of health care delivery. Unfortunately, proposed changes in product selection, delivery, or use may offer improvement in order and flow, in behaviors, in safety, or in efficiency are frequently difficult to visualize based on verbal descriptions or static diagrams. Thus, it is difficult for a product manufacturer and/or seller to demonstrate the superiority of one product over another or the superiority of one proposed solution over another.

### SUMMARY OF THE INVENTION

Embodiments of the invention provide virtual reality tools and simulations used for improved health care customer management. Advantageously, the virtual reality tools may be used by a product manufacturer or seller to assist in relationship management with a health care partner. One embodiment of the invention includes a method of generating a virtual reality simulation to demonstrate a health care product to a representative of a health care customer. The method may generally include retrieving a set of simulation data describing actions of one or more individuals interacting with the health care product and with a physical environment. The interactions model the order and flow of the health care product within the physical environment. The method may also include generating a virtual reality simulation depicting both the physical environment and the order and flow of the health care product within the physical environment and presenting the virtual reality simulation to the representative.

The virtual reality simulation may include one or more avatars representing the individuals described in the set of simulation data. Further, the virtual realty simulation may visually display information related to the modeled environment normally invisible in the physical world. For example, the method may further include retrieving a disease transmission model describing how a pathogen spreads through the physical environment based on the interactions of the one or more individuals and applying the disease transmission model to the simulation data to predict transmission of the pathogen through the physical environment. The virtual reality simulation may provide the representative with a visual indication of the predicted transmission of the pathogen through the physical environment.

Thus, advantageously, the product manufacturer or seller may use the virtual reality tools described herein to demonstrate to a health care customer modified layouts, dispensing systems, products, and so forth, and also receive data from customers while they interact with a virtual environments generated by the virtual realty system. Further, mockups of proposed layouts may also be provided in a facility near the virtual reality system to allow physical interaction with modified systems to further enhance the customer's assessment and understanding of how new products or procedures may improve order and flow within a health care enterprise.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating components of a computing environment and virtual reality tools used for improved health care customer management, according to one embodiment of the invention.

FIG. 2A is a conceptual illustration of components of the virtual reality system first shown in FIG. 1, according to one embodiment of the invention.

FIG. 2B is a conceptual illustration of an immersive virtual reality visualization center, according to one embodiment of the invention.

FIG. 3 is a flow chart illustrating a method for generating a virtual reality simulation used for improved health care customer management, according to one embodiment of the invention.

FIG. 4 is a flow chart illustrating a method for modifying a virtual reality simulation to evaluate order and flow issues regarding product use within a health care environment, according to one embodiment of the invention.

FIG. 5 is a flow chart illustrating a method for managing a relationship with a health care customer using virtual reality simulations, according to one embodiment of the invention.

### DETAILED DESCRIPTION

Embodiments disclosed herein provide virtual reality tools and simulations used for health care customer management. In one embodiment, the virtual reality tools may be used by a product manufacturer or seller to assist in relationship management with health care partners including identifying improved solutions for a variety of problems, strengthening infection prevention processes and systems, improving order and flow in the operating room and other care-delivery environments, identifying benefits from new products, providing techniques for evaluating new health care systems and processes, etc. For example, an immersive virtual reality display platform may be used to demonstrate the effectiveness of proposed changes to a health care customer in procedures, equipment, product selection, dispensing systems, infection control systems, or even layout of rooms that may be readily appreciated using an interactive virtual reality simulation.

Virtual reality simulations may be displayed to a health care customer on a display device depicting a group of health care staff interacting with patients, an environment, and with one another. In one embodiment, a virtual reality system may be used to simulate the real-world physical environment of the customer based on CAD drawings or other means in order to create an accurate representation of the customer's facility. Further, the simulation may use avatars (i.e., a graphical representation of a real person) to illustrate the actions and interactions of the health care staff with patients and with one another. Still further, the content of a virtual reality simulation may recreate what occurred during actual procedures performed by the health care staff.

The virtual reality simulation may depict both current and proposed approaches to a given procedure, allowing the customer to view the settings from multiple perspectives and to simulate moving through the virtual space. For example, the virtual reality system may be used to represent events in the health care environment, such as the motion of humans and activities such as hand washing, performing an operation, restocking supplies, finding or replacing tools and supplies associated with a given procedure, etc. Alternative scenarios may then be explored, such as viewing a simulation of a medical procedure performed under an initial set of conditions and a modified version after proposed in-room equipment is installed, such as a customized hand washing station. Another example includes viewing before and after simulations to explore how tripping hazards in an operating room might be mitigated with new equipment that reduces the use or need for on-floor cables.

The following description references embodiments of the invention. However, it should be understood that the invention is not limited to any specifically described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable media. Illustrative computer-readable media include, but are not limited to: (i) non-writable storage media on which information is permanently stored (e.g., read-only memory devices within a computer such as CD-ROM or DVD-ROM disks readable by a CD-ROM or DVD-ROM drive); (ii) writable storage media on which alterable information is stored (e.g., floppy disks within a diskette drive, hard-disk drives, or flash memory devices). Other media include communications media through which information is conveyed to a computer, such as through a computer or telephone network, including wireless communications networks. The latter embodiment specifically includes transmitting information to/from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

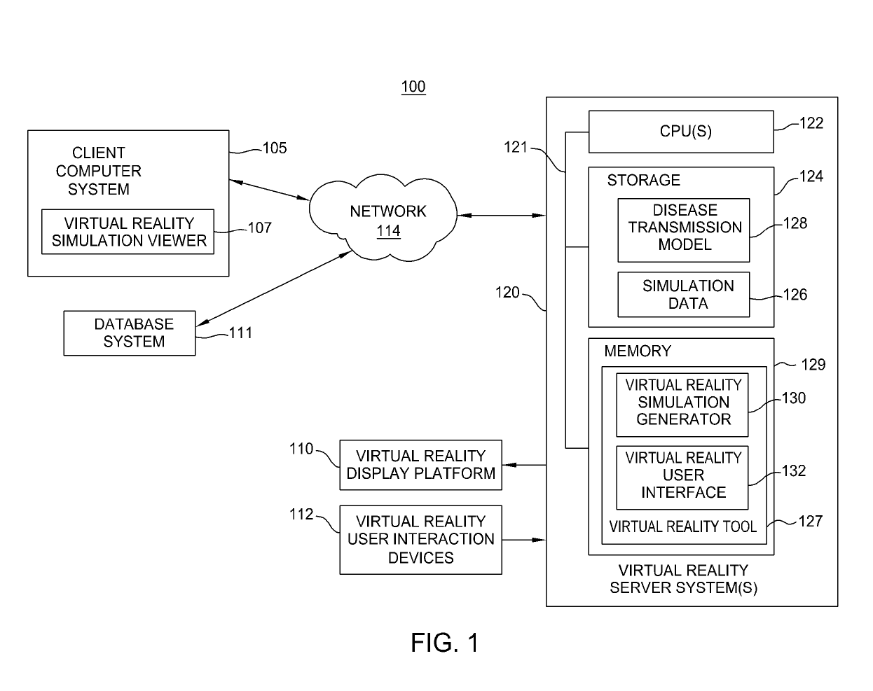

FIG. 1 is a block diagram illustrating components of a computing environment 100 and virtual reality tools used for improved health care customer management, according to one embodiment of the invention. As shown, computing environment 100 includes a client computer system 105 and a database system 111 in communication with a virtual reality server system 120 over a network 114. The computer systems 105, 111, and 120 illustrated in environment 100 are intended to be representative of existing computer systems, e.g., desktop computers, server computers, laptop computers, tablet computers and the like. However, embodiments of the invention are not limited to any particular computing system, application, device, or network architecture and instead, may be adapted to take advantage of new computing systems and platforms as they become available. Additionally, those skilled in the art will recognize that the illustrations of computer systems 105, 111, and 120 are simplified to highlight aspects of the present invention and that computing systems and networks typically include a variety of components not shown in FIG. 1.

As shown, server system 120 includes one or more CPUs 122, storage 124, and memory 129 connected by a bus 121. CPU 122 is a programmable logic device that executes the instructions, logic and mathematical processing as necessary to execute user applications (e.g., a virtual reality tool 127). Storage 124 stores application programs and data for use by server system 120. Common storage devices 124 include hard-disk drives, flash memory devices, optical media and the like. Client system 105 and database system 111 may include similar components (not shown). Client system 105 may be used to execute a virtual reality simulation viewer 107. Simulation viewer 107 may present a user with the content of a virtual reality simulation.

Illustratively, server system 120 includes a virtual reality tool 127 which itself includes a virtual reality simulation generator 130 and a user interface 132. Virtual reality tool 127 may provide a software application configured to generate a virtual reality simulation from simulation data 126. User interface 132 may allow users to interact with and control the actions of virtual reality tool 127.

Simulation data 126 includes any information used by virtual reality simulation generator 130 to generate a given virtual reality simulation or virtual reality environment. In one embodiment, simulation data 126 includes order and flow events for a group of study participants describing human motions, activities, the movement and/or use of selected objects as a function of time and space, etc. Further, simulation data 126 may be used to recreate live situations based on actual order and flow data obtained from a health care facility. Regarding data acquisition, several methods may be used. For example, data regarding human motion may be tracked using badges (worn by human-beings) that contain RFID (radio frequency ID) tags whose location can be determined precisely by triangulating data from multiple RFID readers placed at strategic locations within a hospital environment. In such a case, a week-long data acquisition trial could be conducted for an operating room, and a virtual reality simulation could then be generated to highlight aspects of operating room procedure that could be improved upon.

As another example, participant locations and actions may be tracked using video monitoring tools coupled with pattern recognition/image recognition software tools to identify participants and their actions. Another data acquisition technique includes manual data entry of order and flow events based on a review of captured video footage. In one embodiment, a database on system 111 may be configured to store order and flow data and/or event information for the participants in the study (e.g., extent of and type of contact with a given product, and/or amount of product dispensed or used etc.). In any event, however acquired, data from database system 111 may be transmitted to server system 120 and stored as simulation data 126.

In turn, virtual reality simulation generator 130 may use simulation data 126 to generate a virtual reality simulation replaying a given sequence of events, or creating an immersive virtual environment. In one embodiment, computer-generated avatars may represent humans and 3-D images of objects in the particular environment. The playback of tracked events may provide a baseline for comparison with computer-generated hypothetical scenarios to demonstrate how proposed changes in order and flow or motion, efficiency, and so forth that can be realized with the changes. That is, a virtual reality simulation can significantly enhance a customer's appreciation of how the proposed changes may be used to achieve a particular objective. For example, a virtual reality display platform 110 and/or virtual reality user interaction devices 112 may allow a health care customer to experience rapid “fly-through” motions through the simulated environment or to experience the simulation from the perspective of a given participant. The simulation data 126 may be integrated into a virtual reality simulation that represents the physical space, coupled with avatars (if desired) representing study participants as they move and interact with objects. Human representation is not necessary, however.

Further, in one embodiment, the health care customer may be able to interact with the elements of the virtual reality simulation. For example, a customer may participate in a scenario by controlling how an avatar “moves” through the environment depicted in the virtual reality simulation or participating in a virtual procedure to understand how the proposed change can impact performance. For example, a surgeon could control an avatar representing a virtual surgeon in a simulation of an operating room to better understand how a new product can be used without interfering with order and flow issues.

A disease transmission model 128 may be used to predict the presence of environmental pathogens, where the spread of a pathogen from hands to other surfaces or from one object to other items can be estimated and preferably represented visually. Further, the presence of a pathogen may be presented as glowing regions (e.g., green regions for bacteria considered benign and red regions for bacteria considered potentially harmful). The microbial load of a pathogen may be represented by varying the size and/or the intensity of the glowing region. As an avatar touches a contaminated surface some of the glowing region “transfers” to the avatar, and subsequently, when the avatar touches other surfaces (or individuals) some of the glowing region may continue to “transfer” to each surface the avatar comes in contact with.

In such a case participants observed in the study may be assumed to have a certain microbial loading of a given pathogen on their hands. The load may include ordinary bacterial levels, or arbitrary loadings of ordinary bacteria, antibiotic resistant bacteria, etc. This initial loading can then be an input to a disease transmission model 128, which in turn tracks how the pathogen may spread through the environment as the result of subsequent interactions with surfaces and participants, e.g., based on simulation data 126. The disease transmission model 128 may consider hand washing data for any person being tracked, and data related to duration of washing or other actions may be used to predict changes to the microbial load of the pathogen on the participants' hands after washing. Disease transmission model 128 may be configured to predict a microbial load left on a surface after contact or the load that is picked up from a contaminated surface after contact. The model can also provide for separate consideration of background bacteria or the interaction of multiple pathogens.

The disease transmission model 128 may account for anticipated bacterial growth, as well as for the effectiveness of anti-microbial agents, surfaces, or hand washing activity. Using this information, the virtual reality simulation may also represent the amount of microbes ultimately transferred to a patient by contact with people or with contaminated objects, and can display information about the apparent threat level represented by the transferred microbial loadings.

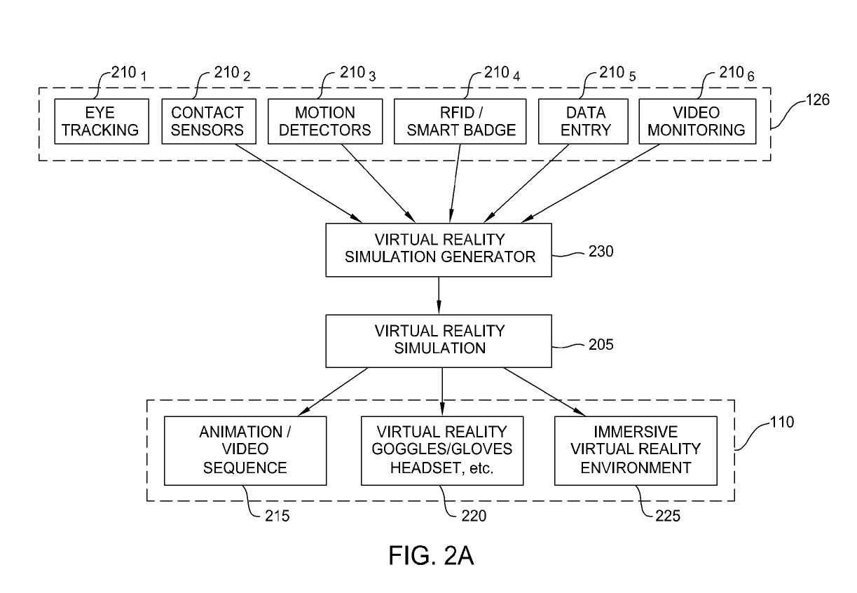

FIG. 2A is a conceptual illustration of components of the virtual reality system first shown in FIG. 1, according to one embodiment of the invention. As shown, simulation data 126 may be collected using a variety of data acquisition systems 210. Each data acquisition system 210 may be used to obtain simulation data 126 related to the actions of health care staff.

Illustratively, data acquisition systems 210 includes video systems 210₆ to monitor, track, and recognize activities such as opening doors, touching patients or objects in a room, hand washing activities, etc. Smart badge systems 210₄ may include RFID or other wireless means to identify the location of health care staff and their proximity to items of interest such as hand washing stations. Wrist bands with RFID tags may also be used on patients or study participants. Motion detection systems 210₃ may include light fields, ultrasonic motion detectors, and other motion or object detection systems. Patient contact sensors 210₂ (e.g., an inductive coil device) may be used to detect changes in electrical properties when another person establishes physical contact with the skin of the patient. Data entry system 210₅ may include human monitors, remote or physically present, may observe and record events of interest. Eye tracking systems 210₁ may be used to monitor and record what a given individual views at any given point in time. For example, an instrumented hand washing station adjacent to an operation room may include eye tracking systems 210₁ to learn what elements of the station may attract the attention of a person while that person interacts with the hand washing station. Of course, other systems may be used. For example, a wireless system designed to track hand washing is disclosed in U.S. Pat. No. 6,392,546, “Hand Washing Compliance Measurement and Recording System,” issued May 21, 2002 to Smith. And an example of an ultrasonic technique for determining hand washing events is disclosed in U.S. Pat. No. 5,573,041, “Dispenser Control with Ultrasonic Position Detection,” issued Nov. 12, 2002 to Skell.

As described above, each of the data acquisition systems 210 may be used by virtual reality simulation generator 130 to generate virtual reality simulation 205. In one embodiment, virtual reality simulation 205 may present a simulation of a given physical environment that includes all the events and actions of the simulation participants, as recorded by the data acquisition systems 210. The resulting virtual reality simulation 205 may be presented on a virtual reality display platform. Illustratively, FIG. 2 shows a variety of virtual reality display platforms 110. As shown, virtual reality display platform 110 includes an animation or simulated video sequence 215 (viewed using virtual reality simulation viewer 107), virtual reality goggles, gloves and/or headset, etc. 220, and an immersive virtual reality environment 225 (e.g., a virtual reality sphere, cave or cube). Of course, the examples shown in FIG. 2 provide examples of virtual reality display platforms 110, and embodiments of the invention may be adapted for use with these, or other virtual reality systems, whether currently known or subsequently developed.

FIG. 2B is a conceptual illustration of an immersive virtual reality visualization center 200, according to one embodiment of the invention. As shown, visualization center 200 includes an immersive virtual reality display platform 110, control systems 212 and 222, virtual reality server system 120, observation gallery 218 and a physical environment mock up 250.

Immersive virtual reality display platform 110 includes a number of components that may be used to provide a simulation participant with an immersive virtual environment. Illustratively, the components include interaction devices 201 allowing a participant to interact with the virtual environment and display panels 204 used to present the participant with a visualization of the virtual environment. Additionally, display platform 110 may include an aroma device 206 and/or sound and vibration devices 208 used to enhance the quality of a virtual reality simulation. The aroma device 206 may be configured to introduce smells or odors into the virtual environment, either on queue, or in response to the participant interacting with one of interaction devices 201. Similarly, sound and vibration devices 208 may play prerecorded audio, or may generate sounds and or motion, vibration, etc., in response to the participant's interaction with one of interaction devices 201.

In one embodiment, these (and other) sensory aspects of the simulation may be controlled by virtual reality server system 120 and control systems 212 and 222. As shown, control systems include an aroma control system 212 (used to control aroma device 206) and sound and vibration control system 222 (used to control sound and vibration device 208). One of ordinary skill in the art will recognize that although shown as separate components, control systems 212 and 22 may be software applications running on server system 120, either as independent processes or part of a single, comprehensive virtual reality tool.

These multi-sensory aspects of a virtual reality simulation may allow a participant to experience not only a realistic environment related to the product, but experience various aspects of interaction with, or use of, the product, including experiencing the benefits of the product. For example, in evaluating a face mask offering odor-control functionality, immersive visualization center 200 can provide a user (e.g., a surgeon, nurse, etc.) with a virtual experience highlighting the actual benefit of a new face-mask design. In such a case, a virtual operating room may be used to provide a realistic model of an operating room in use, and aroma device 206 may be configured to introduce the actual smells that are typically present in such an environment. For example, in settings where ozone may be generated during a procedure, detectable but harmless quantities of ozone or of similar odors may be introduced into the virtual operating environment. The participant may then physically don a face mask being evaluated to directly experience its odor removal capabilities. Alternatively, the performance characteristics of the face mask may be demonstrated by changing the amount of aroma introduced to indicate the effect of odor reduction through use of the face mask.

Physical environment mockup 250 may be used to provide a simulation participant with a physical environment corresponding to one presented on virtual reality display platform 110. In the illustration provided in FIG. 2A, environment mockup 250 includes a mockup for a hand washing station and an operating room configured to correspond to one presented in an immersive virtual reality display platform 110. The combination of virtual and physical prototypes may enhance the ability of a product manufacturer or seller to demonstrate to a health care partner the effectiveness of proposed changes in product solutions, layouts, graphics, lighting, packaging, or other aspects of product use within the order and flow of a medical procedure.

Health care customers may provide feedback regarding their experience in the virtual reality environment provided by immersive virtual reality display platform 110 as well as their experience in physical environment mockup 250. Participant feedback can be verbal, e.g., a question-and-answer session following a simulation, as well as on user actions and choices, as well as physiological and other non-verbal responses. Thus, immersive visualization center 200 may assist a health care customer (e.g., a hospital administrator) understand the benefits of a particular product design or proposed change to the order and flow of a given procedure. Further, the immersive visualization center 200 allows the health care customer to rapidly explore multiple product design and/or store layout scenarios, in both the virtual and physical environments. Observation gallery 218 may allow the product manufacturer (or other relevant party) 216 to observe and/or interact with a participant 214 as they interact with the virtual or physical environment provided by immersive visualization center 200.

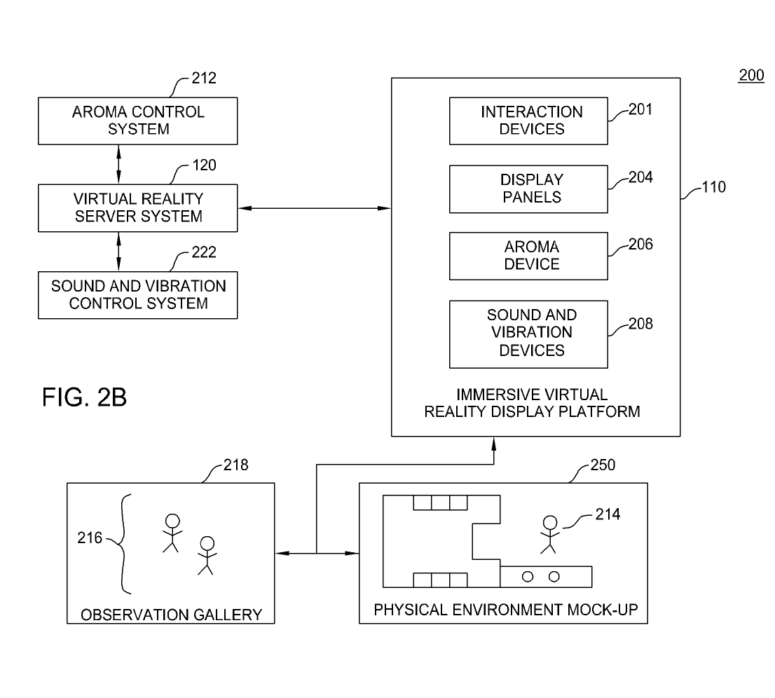

FIG. 3 is a flow chart illustrating a method 300 for generating a virtual reality simulation used for improved health care customer management, according to one embodiment of the invention. As shown, method 300 begins at step 305, where one or more study participants are monitored while interacting within a target environment. As described above, for example, a variety of data acquisition systems may be used to record the actions and interactions of health care staff related to the order and flow of products within a health care environment.

At step 310, a virtual reality tool may use a portion of the data gathered at step 305 to generate a virtual reality simulation depicting the actions of the health care staff. At step 315, the resulting virtual reality simulation may be presented to a health care partner on a virtual reality display platform. For example, as described, a virtual reality simulation may be presented on a computer monitor or TV screen, or in more immersive environments such as a hemispherical virtual reality pod, systems of multiple display panels, or in more environments such as a virtual reality cave. Alternatively, display of 3-D results may be achieved using virtual reality goggles, headsets or other devices. Sound, aroma, and tactile feedback may also be provided to enhance the experience or to communicate additional information regarding, for example, health threats or unacceptable behaviors.

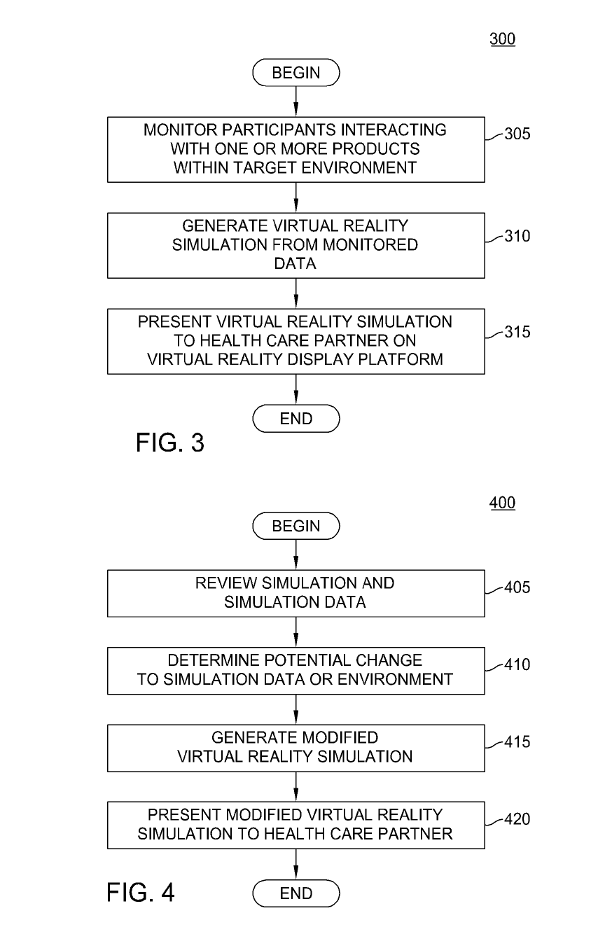

FIG. 4 is a flow chart illustrating a method 400 for modifying a virtual reality simulation to evaluate order and flow issues regarding product use within a health care environment, according to one embodiment of the invention. As shown, method 400 begins at step 405 where a health care customer and a product manufacturer or seller may review a virtual reality simulation and the data used to generate the virtual reality simulation. For example, method 300 may be used to generate the virtual reality simulation based on monitored interaction of hospital staff. At step 410, a proposed change in the simulation data or simulated environment is made. For example, the product manufacturer or seller may propose changes to the use of a given product as part of a medical procedure or to modify the order and flow of how products are used within the virtual reality simulation of the medical procedure. Thus, the virtual reality simulation may be used to explore modified layouts, dispensing systems, products, etc. Further, the customer may provide feedback to the product manufacturer or seller while interacting with the virtual reality system. In such a case, the virtual reality system may enable rapid identification of problematic behaviors and systems, and allow improved training or systemic modifications to be made to reduce the risk of infection.

At step 415, a modified virtual reality simulation is generated, based on the changes identified at step 410. Once generated, at step 420 the modified virtual reality simulation may be presented to the health care customer.

In one embodiment, the virtual reality tool may be configured to display two scenarios simultaneously (e.g., on a split screen or on different walls in a virtual reality cave). Further, an immersive virtual reality center may provide a physical mockup of the physical health care setting being modeled in the virtual reality scenarios, where aspects or one or both scenarios being explored can be given a physical representation that allows the health care customer to assess a proposed product or modification to order and flow in addition to the virtual representations.

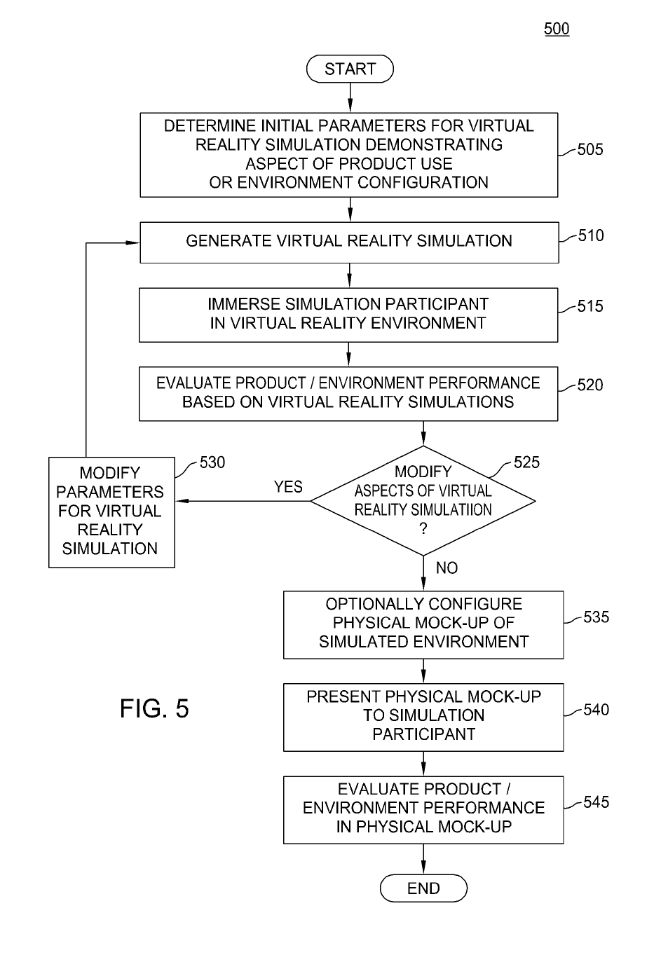

FIG. 5 is a flow chart illustrating a method 500 for managing a relationship with a health care customer using virtual reality simulations, according to one embodiment of the invention. As shown, the method 500 begins at step 505, wherein initial parameters for a virtual reality simulation are determined. The parameters may be selected to demonstrate aspects of product use or environment configuration related to order and flow within a health care environment. For example, a product manufacturer or seller may wish to demonstrate the effectiveness of a new product, or how the effectiveness of that product or efficiency of a given procedure may be improved. In such a case, the initial parameters could be selected to generate a virtual reality simulation depicting current procedures using an existing product.

At step 510, a virtual reality simulation is generated, based on the parameters selected at step 505. At step 515, once the virtual reality simulation is generated, a health care customer may be immersed within the virtual reality environment and presented the virtual reality simulation. As described above in conjunction with FIG. 2B, an immersive virtual reality center may include a virtual reality display platform used to simulate a health care environment. At step 520, the health care customer may evaluate product or environment performance, based on the virtual reality simulation.

Advantageously, however, because the virtual reality simulation is, in fact, a simulation, it may be modified to present many alternatives to the initial parameters selected at step 505. Accordingly, at step 525 the simulation participant (or product manufacturer/seller) may determine to modify aspects of the virtual reality simulation. Continuing with the example above, the product manufacturer may modify the simulation parameters to include the new products or modify aspects of order and flow of product use within the virtual reality simulation. At step 530, the parameters are modified and method 500 returns to step 510 where a modified simulation is generated. The modified simulation is then presented to the health care customer at step 515. Thus, the product manufacturer/seller may rapidly demonstrate to the health care customer differences between exiting products and/or procedures and new products and/or procedures.

Optionally, after demonstrating a variety of different virtual reality simulations to a health care customer, at step 535, a physical mockup may be configured to represent one of the virtual reality simulations. At step 540, the physical mockup may correspond to a preferred environment identified using the virtual reality simulations, or with a preferred product selected from multiple products simulated in different virtual reality simulations. The physical mockup may correspond to the virtual environment presented in the simulations. Further, the product may be based on design choices made by the health care customer as part of the simulation. At step 545, the health care customer may evaluate the product in the physical mockup.

As described herein, embodiments of the invention provide virtual reality tools and simulations used for health care customer management. Advantageously, the virtual reality tools may be used by a product manufacturer or seller to assist in relationship management with health care partners including identifying improved solutions for a variety of problems, strengthening infection prevention processes and systems, improving order and flow in the operating room and other care-delivery environments, identifying benefits from new products, providing techniques for evaluating new health care systems and processes, etc. Accordingly, a product manufacturer or seller may use the virtual reality tools described herein to demonstrate to a health care customer modified layouts, dispensing systems, products, and so forth, and also receive data from customers while they interact with a virtual environments generated by the virtual realty system. Further, mockups of proposed layouts may also be provided in a facility near the virtual reality system to allow physical interaction with modified systems to further enhance the customer's assessment and understanding of how new products or procedures may improve order and flow within a health care enterprise.

Embodiments of the invention may provide advantages over other methods directed to health care customer management. For example, it may be considered to collect data from relevant individuals as to what actions were performed or what procedures were perceived to be effective in a particular case. However, this approach may fail to identify relevant information. Even when participants provide what they believe to be an accurate accounting of a given procedure, people often interact with a product in ways they do not realize making it difficult, if not impossible, to capture accurate information about their experience with a product or approach to health care delivery being evaluated. However, while this approach may be ineffective in and of itself, it is contemplated that data collected in this way may be used advantageously in an embodiment of the present invention. For example, the collected data could be tested against a virtual reality environment in an effort to improve the data collection techniques. Alternatively, to the extent the data collected is considered to be accurately representative of a product or procedure, the data may be used to configure the virtual reality environment.

While the foregoing is directed to embodiments of the present invention, other and further embodiments of the invention may be devised without departing from the basic scope thereof, and the scope thereof is determined by the claims that follow.

What is claimed is:

1. A computer-implemented method of generating a virtual reality simulation to demonstrate a health care product to an observer, comprising:
retrieving a set of simulation data describing actions of one or more individuals interacting with the health care product and with a physical environment, wherein the interactions model an order and flow of the health care product within the physical environment;
generating a virtual reality simulation depicting both the physical environment and the order and flow of the health care product within the physical environment; and
presenting the virtual reality simulation to the observer.

2. The method of claim 1, wherein the physical environment is an operating room, and wherein the order and flow of the product simulates how the health care product is used as part of a medical procedure performed on a patient.

3. The method of claim 1, wherein the virtual reality simulation includes one or more avatars representing the individuals described in the set of simulation data.

4. The method of claim 1, further comprising:
retrieving a disease transmission model describing how a pathogen spreads through the physical environment based on the interactions of the one or more individuals; and
applying the disease transmission model to the simulation data to predict transmission of the pathogen through the physical environment; and
wherein the virtual reality simulation provides the observer with a visual indication of the predicted transmission of the pathogen through the physical environment.

5. The method of claim 1, further comprising:
receiving a selection of a modification to the set of simulation data;
generating a second virtual reality simulation depicting both the physical environment and changes to the order and flow of the health care product within the physical environment based on the modification to the set of simulation data; and
presenting the second virtual reality simulation to the observer.

6. The method of claim 5, further comprising, simultaneously presenting the virtual reality simulation and the second virtual reality simulation to the observer in order to highlight differences to the order and flow of the health care product within the physical environment resulting from the modification to the set of simulation data.

7. The method of claim 1, further comprising:
presenting the observer with a physical mock-up environment, wherein the physical mock-up environment corresponds to the environment presented in the virtual reality simulation; and
monitoring the observer interacting with the product in the physical mockup environment to demonstrate how the order and flow of the health care product within the physical environment corresponds to the order and flow of the health care product included in the virtual reality simulation.

8. The method of claim 1, further comprising, monitoring a plurality of individuals providing health care services within the physical environment including monitoring the individuals' use of the product in the physical environment, wherein the set of simulation data is generated with the monitored interactions.

9. A computer-readable storage medium containing a program configured to generate a virtual reality simulation to demonstrate a health care product to an observer, the operation comprising:
retrieving a set of simulation data describing actions of one or more individuals interacting with the health care product and with a physical environment, wherein the interactions model an order and flow of the health care product within the physical environment;
generating a virtual reality simulation depicting both the physical environment and the order and flow of the health care product within the physical environment; and
presenting the virtual reality simulation to the observer.

10. The computer-readable storage medium of claim 9, wherein the physical environment is an operating room, and wherein the order and flow of the product simulates how the health care product is used as part of a medical procedure performed on a patient.

11. The computer-readable storage medium of claim 9, wherein the operation further comprises:
retrieving a disease transmission model describing how a pathogen spreads through the physical environment based on the interactions of the one or more individuals; and
applying the disease transmission model to the simulation data to predict transmission of the pathogen through the physical environment; and
wherein the virtual reality simulation provides the observer with a visual indication of the predicted transmission of the pathogen through the physical environment.

12. The computer-readable storage medium of claim 9, wherein the operation further comprises:
receiving a selection of a modification to the set of simulation data;
generating a second virtual reality simulation depicting both the physical environment and changes to the order and flow of the health care product within the physical environment based on the modification to the set of simulation data; and
presenting the second virtual reality simulation to the observer.

13. The computer-readable storage medium of claim 12, wherein the operation further comprises, simultaneously presenting the virtual reality simulation and the second virtual reality simulation to the observer in order to highlight differences to the order and flow of the health care product within the physical environment resulting from the modification to the set of simulation data.

14. The computer-readable storage medium of claim 9, wherein the operation further comprises:
presenting the observer with a physical mock-up environment, wherein the physical mock-up environment corresponds to the environment presented in the virtual reality simulation; and
monitoring the observer interacting with the product in the physical mockup environment to demonstrate how the order and flow of the health care product within the physical environment corresponds to the order and flow of the health care product included in the virtual reality simulation.

15. The computer-readable storage medium of claim 9, wherein the operation further comprises, monitoring a plurality of individuals providing health care services within the physical environment including monitoring the individuals' use of the product in the physical environment, wherein the set of simulation data is generated with the monitored interactions.

16. A system, comprising:
a processor;
a memory storing a virtual reality tool, wherein the virtual reality tool is configured to:
retrieve a set of simulation data describing actions of one or more individuals interacting with the health care product and with a physical environment, wherein the interactions model an order and flow of the health care product within the physical environment;
generate a virtual reality simulation depicting both the physical environment and an order and flow of the health care product within the physical environment; and
present the virtual reality simulation to an observer.

17. The system of claim 16, wherein the physical environment is an operating room, and wherein the order and flow of the health care product simulates how the health care product is used as part of a medical procedure performed on a patient.

18. The system of claim 16, wherein the virtual reality simulation includes one or more avatars representing the individuals described in the set of simulation data.

19. The system of claim 16, wherein the virtual reality tool is further configured to:
retrieve a disease transmission model describing how a pathogen spreads through the physical environment based on the interactions of the one or more individuals;
apply the disease transmission model to the simulation data to predict transmission of the pathogen through the physical environment; and
wherein the virtual reality simulation provides the observer with a visual indication of the predicted transmission of the pathogen through the physical environment.

20. The system of claim 16, wherein the virtual reality tool is further configured to:
receive a selection of a modification to the set of simulation data;
generate a second virtual reality simulation depicting both the physical environment and changes to the order and flow of the health care product within the physical environment based on the modification to the set of simulation data; and
present the second virtual reality simulation to the observer.

21. The system of claim 20, wherein the virtual reality tool is further configured to, simultaneously present the virtual reality simulation and the second virtual reality simulation to the observer in order to highlight differences to the order and flow of the health care product within the physical environment resulting from the modification to the set of simulation data.

22. The system of claim 16, the virtual reality tool is further configured to:
present the observer with a physical mock-up environment, wherein the physical mock-up environment corresponds to the environment presented in the virtual reality simulation; and
monitor the observer interacting with the health care product in the physical mockup environment to demonstrate how the order and flow of the health care product within the physical environment corresponds to the order and flow of the health care product included in the virtual reality simulation.

23. The system of claim 16, further comprising:
a data acquisition system configured to monitor a plurality of individuals providing health care services within the physical environment including monitoring the individuals use of the health care product in the physical environment, wherein the set of simulation data is generated with the monitored interactions.

24. The system of claim 23, wherein the data acquisition system includes at least on of a video recording system, a motion sensing system, an eye movement tracking system, and a data entry system.

25. A computer-implemented method for a product manufacturer to manage a relationship with a health care customer that uses one or more products manufactured by the product manufacturer, comprising:
generating a virtual reality simulation depicting both a physical environment and an order and flow of a health care product within the physical environment;
presenting the virtual reality simulation to a simulation participant on a virtual reality display platform;
monitoring the simulation participant interacting with the simulation of the product and the physical environment provided by the virtual reality simulation;
presenting the simulation participant with a physical mock-up environment, wherein the physical mock-up environment corresponds to the physical environment presented in the virtual reality simulation; and
monitoring the simulation participant interacting with a product prototype in the physical mockup environment, wherein the product prototype corresponds to the product included in the virtual reality simulation.
